(19) United States
(12) Patent Application Publication
(10) Pub. No.: US 2008/0305783 A1
(43) Pub. Date: Dec. 11, 2008

(54) Conference Presentation System

(75) Inventors: Fu-Hsiang Liu, Taipei (TW); Meng-Jia Guo, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTeK COMPUTER INC., Taipei (TW)

(21) Appl. No.: 12/127,960

(22) Filed: May 28, 2008

(30) Foreign Application Priority Data
Jun. 7, 2007 (TW) 96120584

(51) Int. Cl. H04M 3/56

(52) U.S. Cl. 455/416

(57) ABSTRACT

The invention provides a conference presentation system consisting of a portable presentation controller and a main body. The portable presentation controller can be connected to or disconnected from the main body. Since the portable presentation controller itself has a wireless communication function, the conference presentation system of the invention can provide a complex multi-function system having a conference system, a presentation controller, a mobile microphone, a loudspeaker, a music station and so on.

### RELATED APPLICATIONS

This application claims priority to Taiwan Application Serial Number 96120584, filed Jun. 7, 2007, which is herein incorporated by reference.

### BACKGROUND OF THE INVENTION

1. Field of the Invention

The invention relates to a conference presentation system and, more particularly, to a conference presentation system consisting of a portable presentation controller having a wireless transmission function and a main body.

2. Description of the Related Art

All conventional presentation systems are connected to computers in a wired mode, and all reporters need to operate computer interfaces as they report. When the reporters report, they are completely limited to positions where the computers are placed. Therefore, the reporters cannot move among the listeners to interact with listeners, or the reporters need to prompt computer operators via eyes to turn pages. When the reporters interact with the listeners, the reporters even need to tell the computer operators to switch to some page during the report process. The reporters can communicate with the listeners according to shown content only after the computer operators switch to a last page, a next page or some page, close the presentation or switch to other files.

A presentation system which can be operated by a reporter in real time is provided to solve the above problem, and functions such as a microphone function and a sound playing function are added to increase functions and additional application value of products.

### BRIEF SUMMARY OF THE INVENTION

The invention provides a conference presentation system and mostly provides a portable presentation controller having a wireless transmission function such as the bluetooth technology. The portable presentation controller can be connected to a main body via a detachable transmission interface to form the conference presentation system. A user can conveniently connect the portable presentation controller to the main body to be used or disconnect the portable presentation controller from the main body to be independently used according to different usage conditions. Therefore, the functions of a conference system, a presentation system, a music station, a loudspeaker, a presentation controller, a remote controller and so on are integrated to form a multi-functional system to increase functions and additional value of products.

To achieve the above objective, a presentation controller with a bluetooth interface is provided. According to a preferred embodiment of the invention, since the portable presentation controller itself has a wireless communication unit such as a bluetooth interface which is used to realize the wireless communication in a region, the portable presentation controller can be connected to a desktop personal computer, a notebook computer and a tablet personal computer having a wireless communication function to turn pages during the presentation process or realize a mobile microphone function of the portable presentation controller.

To achieve the above objective of the invention, a remote controller with a bluetooth wireless interface is provided. According to a preferred embodiment of the invention, a portable presentation controller provides a key input interface for a user, and it is connected to an external information device via the signal processing unit to transmit data signals in a wired or wireless transmission mode. Therefore, the user can directly operate an external information device such as a desktop personal computer, a notebook computer, a tablet personal computer, a personal digital assistant, a handheld information processing device or a mobile phone via the portable presentation controller. For example, the user can operate application software (such as instant information software and music playing software), turn pages and dial a network telephone or a mobile phone via the portable presentation controller. A handsfree function of the mobile phone and the network telephone is provided.

To achieve the above objective of the invention, a sound integrator having a sound amplification function, a music playing function and a conference function is provided. According to a preferred embodiment of the invention, the main body can be directly connected to the external information device via the transmission unit in a wired mode to provide a conventional sound playing function to play sound files and music files. A handsfree function of the mobile phone and the network telephone is provided in the external information device, too. The main body can also include a sound receiving and playing function, and then the main body can be independently used as a conventional loudspeaker, a conventional reproducing device or a conventional microphone. Therefore, the conference presentation system of the invention provides a complex sound integrator including a conference system, a presentation controller, a mobile microphone, a loudspeaker and a music station.

### BRIEF DESCRIPTION OF THE SEVERAL VIEWS OF THE DRAWINGS

These and other features, aspects, and advantages of the present invention will become better understood with regard to the following description, appended claims, and accompanying drawings.

FIG. 1 is a block diagram showing a conference presentation system of a first embodiment of the invention;

FIG. 2 is a schematic diagram showing a conference presentation system of a second embodiment of the invention; and

FIG. 3A and FIG. 3B are schematic diagrams showing conference presentation system of a third embodiment of the invention.

### DETAILED DESCRIPTION OF THE EMBODIMENTS

The invention provides a conference presentation system and mostly provides a portable presentation controller having a wireless transmission function. The portable presentation controller can be connected to a main body via a detachable transmission interface to form the conference presentation system of the invention. The content and technology of the invention is illustrated with a preferred embodiment of the invention hereinbelow.

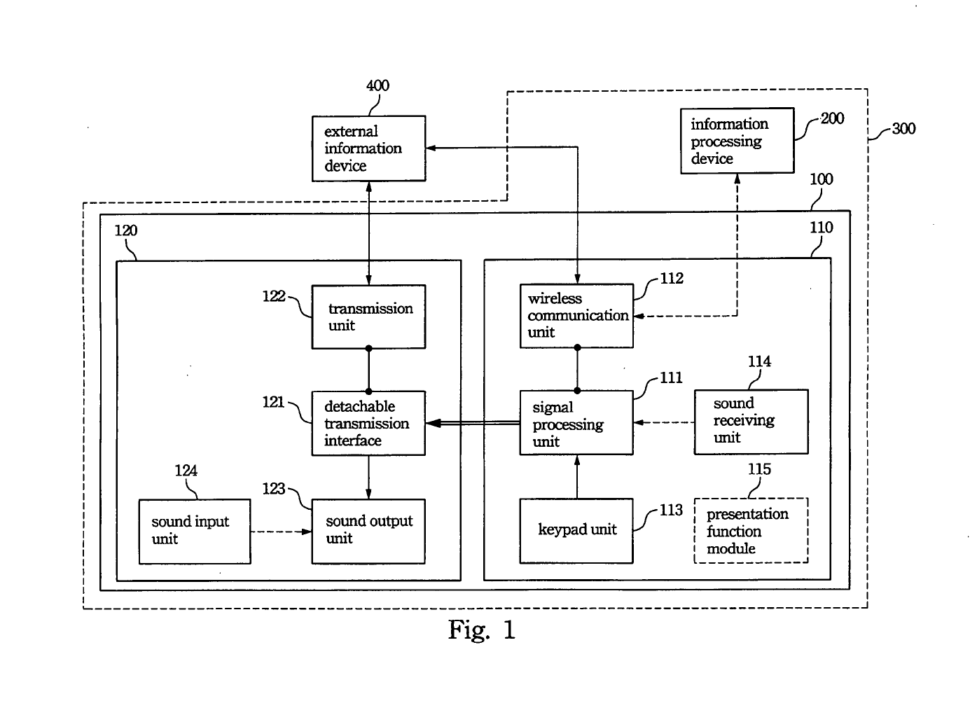

FIG. 1 is a block diagram showing a conference presentation system of a first embodiment of the invention. The invention provides a conference presentation system 300 consisting of an information processing device 200 and a conference presentation device 100. The information processing device 200 has a presentation module which is a presentation application program installed at the information processing device 200. The conference presentation device 100 has a portable presentation controller 110 and a main body 120. The portable presentation controller 110 at least includes a signal processing unit 111, a wireless communication unit 112 and a keypad unit 113. The keypad unit 113 provides an operation interface for a user to receive an input signal and transmits the input signal to the signal processing unit 111. The signal processing unit 111 is connected to the keypad unit 113 to receive the input signal to convert it to a control information. The wireless communication unit 112 is connected to the signal processing unit 111 to provide a wireless communication function. The wireless communication unit 112 can be wirelessly connected to the information processing device 200. The main body 120 at least includes a detachable transmission interface 121 and a sound output unit 123. The detachable transmission interface 121 has a detachable connecting interface for the portable presentation controller 110 to connect to or disconnect from the main body 120. When the portable presentation controller 110 is connected to the detachable transmission interface 121, the control information can be transmitted to the main body 120. The sound output unit 123 provides a sound playing function.

The wireless communication unit 112 is a communication unit such as bluetooth utilizing wireless connecting technology in a region. The detachable transmission interface 121 is a detachable connecting structure for connecting the portable presentation controller 110 to or disconnecting the portable presentation controller 110 from the main body 120. When the portable presentation controller 110 is connected to the main body 120, the detachable transmission interface 121 is used to transmit signal data between the portable presentation controller 110 and the main body 120. The transmission unit 122 is one of a personal system/2 (PS/2) port, a universal serial bus (USB), a flash memory card transmission interface, a firewire port and a personal computer memory card international association (PCMCIA) transmission interface. The transmission unit 122 may further include a sound input output terminal for connecting a conventional audio connecting wire to allow the main body 120 to provide a conventional loudspeaker function. The sound output unit 123 may further have a volume adjustment function. The keypad unit 113 provides a key input interface for a user to directly operate the external information device 400 via the signal processing unit 111. The signal processing unit 111 is connected to the external information device 400 in a wired or wireless mode for transmitting data signals. The external information device 400 is for example a desktop personal computer, a notebook computer, a tablet personal computer, a personal digital assistant, a handheld information processing device or a mobile phone.

The system may further include a sound input unit 124 which is disposed at the main body 120 and is used for receiving sounds, and sound signals are outputted via the sound output unit 123. Therefore, the main body 120 may be independently used as a loudspeaker having a sound receiving and playing function. The system may further include a sound receiving unit 114 which is disposed at the portable presentation controller 110 and is used for receiving sounds and transmitting sound signals to the signal processing unit 111. When the portable presentation controller 110 is connected to the main body 120, they can be connected to the external information device via the transmission unit 122 to transmit the sound signals. The portable presentation controller 110 can also directly transmit the sound signals to the external information device 400 wirelessly via the wireless communication unit 112, and then the sounds are played by the sound output unit 123. The portable presentation controller 110 may further be provided with a presentation function module 115 for providing presentation auxiliary functions such as a laser pointer function. The sound output unit 123 may further provide a volume adjustment function.

FIG. 1 is a schematic diagram showing a conference presentation system of a first embodiment of the invention. That is, the portable presentation controller 110 of the conference presentation system 300 of the first embodiment of the invention is connected to the main body 120 via the detachable transmission interface 121. As for the conference presentation system 300 of the first embodiment of the invention, when the portable presentation controller 110 is connected to the main body 120 via the detachable transmission interface 121, the conference presentation system 300 can be connected to the external information device 400 in a wired mode via the transmission unit 122. The conference presentation system 300 can also wirelessly transmit data signals to the external information device 400 having a wireless communication function via the wireless communication unit 112 of the portable presentation controller 110 directly.

In this way, the user can input operation signals via the key input interface of the keypad unit 113 to directly operate the external information device 400 via the wired connection between the transmission unit 122 and the external information device 400. The user can also directly operate the external information device 400 via the wireless communication between the wireless communication unit 112 of the portable presentation controller 110 and the external information device 400. For example, the keypad unit 113 may include a numeric dial key, and therefore, the user can directly operate the external information device 400 via the wired or wireless connection between the conference presentation system 300 and the external information device 400 to operate instant information software, dial a network telephone or directly dial a mobile phone. During the presentation process, the user can input a signal for turning pages via the keypad unit 113 to control the external information device 400 to turn pages of the presentation data.

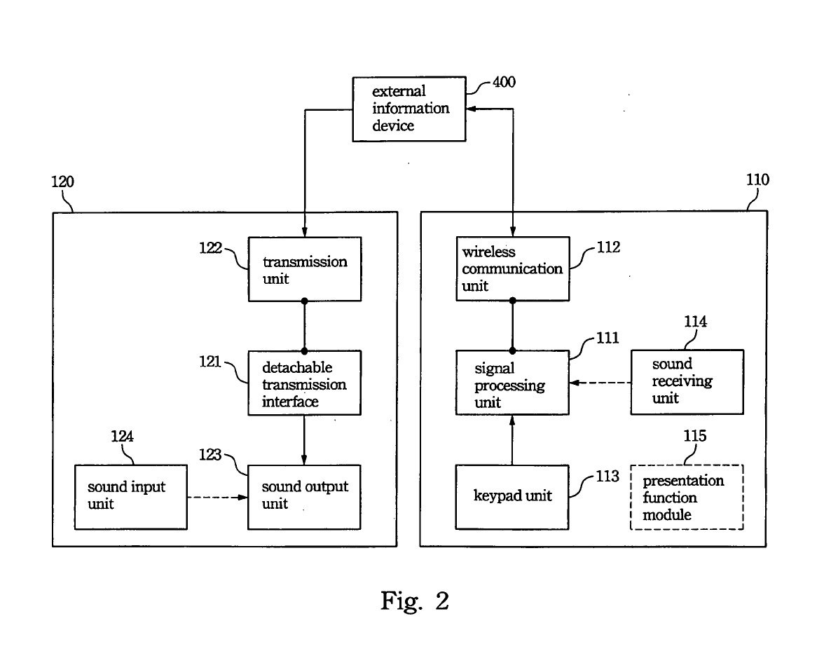

FIG. 2 is a schematic diagram showing a conference presentation system of a second embodiment of the invention. That is, the portable presentation controller 110 and the main body 120 of the conference presentation system 300 are disconnected to be used. The portable presentation controller 110 can utilize its wireless communication unit 112 to be connected to the external information device 400 having a wireless communication function to transmit information. The main body 120 can be connected to the external information device 400 via the transmission unit 122 in a wired mode for transmitting information. The portable presentation controller 110 wirelessly transmits information to the external information device 400. Therefore, a user can directly operate the external information device 400 via the keypad unit 113. Furthermore, since the external information device 400 can be connected to the main body 120 via the transmission unit 122 in a wired mode, the information signals can be transmitted to the main body 120 from the external information device 400. In this way, the sound receiving unit 114 disposed at the portable presentation controller 110 can provide a sound receiving function and allow the sound signals to be wirelessly transmitted to the external information device 400. Then the sound signals are transmitted to the main body 120 via the wired connection of the transmission unit 122. Finally, the sound signals are played by the sound output unit 123. In this way, the portable presentation controller 110 may be provided with a mobile microphone, and the sound signals are wirelessly transmitted to the external information device 400. Sounds can also be played via the sound output unit 123 connected to the main body 120 besides the sound playing device of the external information device 400. Therefore, the portable presentation controller 110 can be used as a mobile microphone, and the main body 120 can be regarded as a loudspeaker at a fixed point.

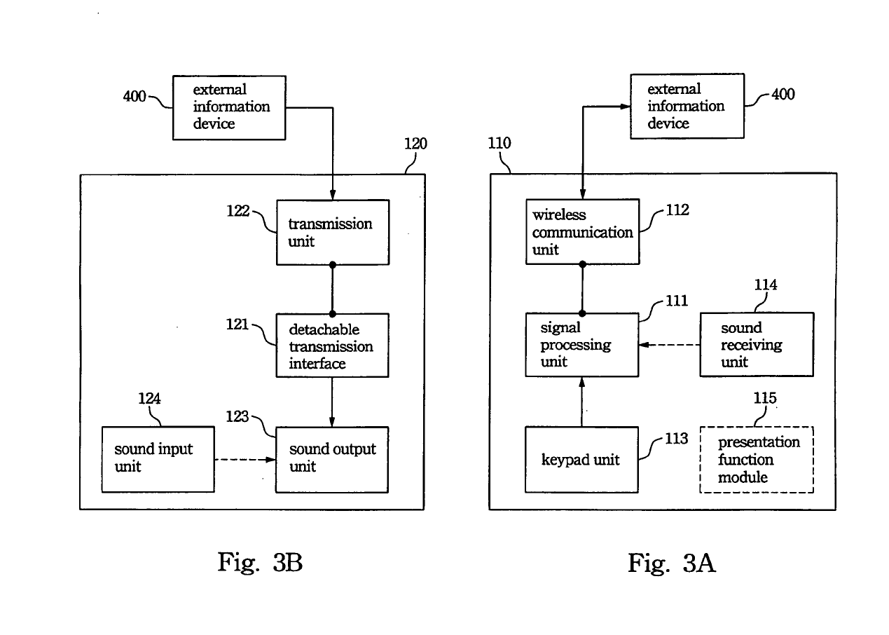

FIG. 3A and FIG. 3B are schematic diagrams showing a conference presentation system of a third embodiment of the invention. That is, the portable presentation controller 110 and the main body 120 of the third embodiment of the invention are independently used, respectively. In FIG. 3A, the portable presentation controller 110 itself has the wireless communication unit 112 which realizes the wireless communication such as bluetooth in a region. Therefore, the portable presentation controller 110 can be used to operate the external information device 400 via the wireless connection between the portable presentation controller 110 and the external information device 400. The external information device 400 is like a desktop personal computer, a notebook computer, a tablet personal computer, a personal digital assistant, a handheld information processing device or a mobile phone to operate the instant information software, dial a network telephone or a mobile phone or turn pages of a presentation

In FIG. 3B, the transmission unit 122 of the main body 120 may be a transmission interface such as a PS/2 port, a USB, a flash memory card, a firewire port or a PCMCIA. Therefore, the main body 120 can be connected to an information device such as a desktop personal computer, a notebook computer, a tablet personal computer, a personal digital assistant, a handheld information processing device or a mobile phone in the wired mode. The transmission unit 122 may further include a sound input output terminal for connecting a conventional audio connecting wire. In this way, when the main body 120 is independently used, it can provide a function of playing sounds and music like a loudspeaker of a conventional audio. The sound input unit 124 disposed at the main body 120 is used to receive sounds, and the sounds are played by the sound output unit 123 to provide functions of the conventional microphone and the loudspeaker.

Based on the above preferred embodiments of the invention, the invention has the following advantages. The main body can be connected to the external information device via a transmission wire to have a data transmission function. When the portable presentation controller is connected to the main body, it can transmit data to the external information device via the main body and even directly operate the external information device. Since the portable presentation controller itself has a wireless transmission function, it is not limited to be connected to the external information device via the main body. It can transmit data to the external information device having a wireless transmission function and even directly operate the external information device. Therefore, the portable presentation controller can be connected to or disconnected from the main body according to different usage conditions. Via the key input function of the portable presentation controller, a user can directly operate the external information device to operate application software (such as instant information software and music playing software) to turn pages of a presentation data, dial a network telephone or a mobile phone. A mobile microphone function also may be added to the portable presentation controller.

The portable presentation controller can be connected to or disconnected from the main body and has a wireless transmission function, and therefore, the portable presentation controller and the main body can be carried according to usage conditions. Since the portable presentation controller and the main body can transmit data to the external information device, they can be applied in any occasion, and especially, the portable presentation controller can be disconnected from the main body to be independently used. Via the key input function of the portable presentation controller, a user can directly operate the external information device to operate the instant information software, dial a network telephone or a mobile phone. The main body can be directly connected to the external information device via the transmission unit in a wired mode to provide a conventional sound playing function for playing sound files and music files in the external information device and a handsfree function of the mobile phone and the network telephone. The main body can also include a sound receiving and playing function, and then the main body can be independently used as a conventional loudspeaker, a conventional reproducing device or a conventional microphone. Therefore, the conference presentation system of the invention provides a complex multi-function system including a conference system, a presentation controller, a mobile microphone, a loudspeaker and a music station.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A conference presentation device applied to an information processing device having a presentation module, the conference presentation device comprising:
a portable presentation controller comprising a keypad unit for receiving an input signal, a signal processing unit connected to the keypad unit and receiving the input signal to convert it to a control information, and a wireless communication unit connected to the signal processing unit and wirelessly connected to the information processing device; and
a main body comprising a detachable transmission interface having a detachable connecting interface for the portable presentation controller to connect to or disconnect from the main body, wherein when the portable presentation controller is connected to the detachable transmission interface, the control information is allowed to be transmitted to the main body, and a sound output unit for playing sounds;
wherein when the portable presentation controller is disconnected from the detachable transmission interface, the control information is transmitted to the presentation module via the wireless communication unit.

2. The conference presentation device according to claim 1, wherein when the portable presentation controller is connected to the detachable transmission interface, the main body can be wirelessly connected to an external information device.

3. The conference presentation device according to claim 2, wherein the main body comprises a transmission unit for transmitting data, and when the portable presentation controller is connected to the detachable transmission interface, the main body can be connected to the external information device via the transmission unit.

4. The conference presentation device according to claim 3, wherein the transmission unit comprises a personal system/2 (PS/2) port, a universal serial bus (USB), a flash memory card transmission interface, a firewire port, a personal computer memory card international association (PCMCIA) transmission interface or a sound input output terminal.

5. The conference presentation device according to claim 1 further comprising a sound input unit, wherein the sound input unit is disposed at the main body to provide a sound receiving function, and allows a sound signal to be outputted.

6. The conference presentation device according to claim 1 further comprising a sound receiving unit which is disposed at the portable presentation controller to provide a sound receiving function, and transmits sound signals to the signal processing unit.

7. The conference presentation device according to claim 1, wherein the wireless communication unit is a communication unit which utilizes a wireless connecting technology in a region and comprises a bluetooth interface.

8. The conference presentation device according to claim 1, wherein the keypad unit provides an operation interface for a user to directly operate the information processing device and further comprises a numeric dial key.

9. The conference presentation device according to claim 5, wherein the sound output unit further comprises a volume adjustment function.

10. The conference presentation device according to claim 1 further comprising a presentation function module disposed at the portable presentation controller to provide a presentation auxiliary function with a laser pointer function.

11. A conference presentation system comprising:
an information processing device having a presentation module; and
a conference presentation device comprising:
a portable presentation controller comprising:
a keypad unit for receiving an input signal;
a signal processing unit connected to the keypad unit and receiving the input signal to convert it to a control information; and
a wireless communication unit connected to the signal processing unit and wirelessly connected to the information processing device; and
a main body comprising:
a detachable transmission interface connected with the portable presentation controller to transmit the control information to the main body; and
a sound output unit for playing sounds,
wherein when the portable presentation controller is disconnected from the detachable transmission interface, the control information is transmitted to the presentation module via the wireless communication unit.

12. The conference presentation system according to claim 11, wherein when the portable presentation controller is connected to the detachable transmission interface, the main body is capable of being wirelessly connected to an external information device.

13. The conference presentation system according to claim 12, wherein the main body comprises a transmission unit for transmitting data, and when the portable presentation controller is connected to the detachable transmission interface, the main body can be connected to the external information device via the transmission unit.

14. The conference presentation system according to claim 13, wherein the transmission unit comprises a PS/2 port, a USB, a flash memory card transmission interface, a firewire port, a PCMCIA transmission interface or a sound input output terminal.

15. The conference presentation system according to claim 11 further comprising a sound input unit, wherein the sound input unit is disposed at the main body to provide a sound receiving function and allows a sound signal to be outputted.

16. The conference presentation system according to claim 11 further comprising a sound receiving unit which is disposed at the portable presentation controller to provide a sound receiving function, and transmits a sound signal to the signal processing unit.

17. The conference presentation system according to claim 11, wherein the wireless communication unit is a communication unit which utilizes a wireless connecting technology in a region and comprises a bluetooth interface.

18. The conference presentation system according to claim 11, wherein the keypad unit provides an operation interface for a user to directly operate the information processing device and further comprises a numeric dial key.

19. The conference presentation system according to claim 15, wherein the sound output unit further comprises a volume adjustment function.

20. The conference presentation system according to claim 11 further comprises a presentation function module disposed at the portable presentation controller to provide a presentation auxiliary function with a laser pointer function.
